(19) United States
(12) Patent Application Publication
(10) Pub. No.: US 2013/0211919 A1
(43) Pub. Date: Aug. 15, 2013

(54) System and Method for Sharing and Endorsing Content

(71) Applicant: Robert Doherty, San Diego, CA (US)

(72) Inventor: Robert Doherty, San Diego, CA (US)

(21) Appl. No.: 13/768,642

(22) Filed: Feb. 15, 2013

Related U.S. Application Data
(60) Provisional application No. 61/599,047, filed on Feb. 15, 2012.

(51) Int. Cl. G06Q 30/02

(52) U.S. Cl. CPC G06Q 30/0267
USPC 705/14.64; 705/14.73

(57) ABSTRACT

A system and associated method to enable individual users of the system to preferably share and/or endorse a set of information by actively embedding the information within a user's existing communications, which include but are not limited to a laptop computer, a desktop computer, a smart phone, a tablet, or any other similar networked and internet-ready device. Additionally, the system is preferably configured to enable a content creator to monitor the content distribution to users of the system in real-time.

### CROSS REFERENCE TO RELATED APPLICATION

This application takes priority from and claims the benefit of U.S. Patent application No. 61/599,047 filed on Feb. 15, 2012, the contents of which are herein incorporated by reference.

### BACKGROUND OF THE INVENTION

1. Field of the Invention

The instant invention relates generally to systems and methods for disseminating advertisements via the internet, and more particular to a system and method for disseminating content via the internet involving the active collaboration of content creators and users of the system.

2. Description of the Related Art

Online advertising has become a major industry. As consumers increasingly shift their attention away from traditional forms of media such as television and newspapers, advertisers have countered with ways to regain their market's attention through the use of mobile, electronic, and internet-based means.

In the past, online advertising primarily focused on placing advertisements as images next to viewed website content. One issue associated with this form of advertising is how to maximize a reader's attention to the advertisement while not detracting from entertaining or desirable content in the webpage. If the advertisement is too large, it can be viewed as obtrusive and have the negative effect of annoying the reader; too small, and it may never be noticed.

Website advertisers have sought other ways to increase reader attention, including placing advertisements in pop-up windows, incorporating text call-out balloons, or animating an advertisement with flashing colors or sounds. While each method undoubtedly accomplishes the goal of capturing a reader's attention, they have the unfortunate side effect of splitting attention between advertising and website content. This may result in a negative impression of the advertisement and less frequent return visits to the website. Similarly, attempts to interrupt the website viewing experience with a full-screen advertisement are usually met with a hurried click to close the window.

From these humble origins, online advertising has become increasingly sophisticated. Currently, some new forms of online advertising focus on targeting relevant segments of the population. By focusing on individual characteristics such as browsing history, personal preferences, and voluntarily entered information, advertisers can build and mine an electronic database to select advertisements most appropriate for a particular viewer of a website. While effective, this form of advertising implicates fundamental privacy concerns and is increasingly becoming a target of legislation both internationally and within the United States.

### SUMMARY OF THE INVENTION

The instant system and method, as illustrated herein, is clearly not anticipated, rendered obvious, or even present in any of the prior art mechanisms, either alone or in any combination thereof. Thus the several embodiments of the instant apparatus are illustrated herein.

In its broadest interpretation, this disclosure describes methods and systems for disseminating advertisements via the internet. In one aspect, the invention results from the realization that the problem of eliminating end-user annoyance in online advertising is solved by a system and method of online advertising that incorporates the end-user and viewer as a disseminator of online advertising. Content creators and advertisers place advertisements in an online system, where end-users may select them as a preferred product and incorporate them in aspects of any form of online communication. The end-user is encouraged to participate in the service through incentives such as credits, free products, or actual currency. The friends, associates, and followers of the end-user view the advertisements and know that the product is recommended by the end-user. Privacy concerns are met by anonymizing all collected user and transactional data.

It is an object of the instant system and method to provide a means of online advertising that lets content creators and users of the system to work together to effectively deliver targeted content, in the form of advertisements and other similar communication means.

It is an object of the instant system and method to provide a means of online advertising that lets content creators and end-users work together to effectively deliver targeted advertisements.

It is another object of the instant system and method to anonymize data to remove privacy concerns.

It is a further object of the instant system and method to provide incentives for end-users to deliver targeted content.

It is yet another object of the instant system and method to provide an easy-to-use downloadable application to an internet-connected device to allow end-users to select content from content creators.

In one embodiment, a content creator logs in to an online website and accesses a content creator application to create a profile and upload content that he or she wishes to share with the population. This content could include, but is not limited to, advertising, data, media, and messaging. The content provider then purchases a block of messaging access, which allows a certain number of disseminations of content. Uploaded content and related information are stored and indexed in a central database server. The content creator application assists the content provider with managing and accessing information, such as content, transmission data, and purchase requests, stored by the central server database.

An end-user then downloads an application to a mobile device, creating a profile that includes basic demographic information, a method of contact, payment information, and other relevant information. The end-user can then select from a list of content providers that he or she wishes to endorse or share in their messages. The application sends this information to the central server database, which sends relevant content back to the end-user's mobile device and embeds it into the end-user's communications, such as SMS messaging, instant messaging, or email. All usage information and attributes from the end-user's profile are saved, uploaded to the central server database, and anonymized.

Collectively, all end-user data is saved to the central server database. A data analysis server analyzes this data to generate information about revenues, payments, and rewards for individual users, and also monitors content distribution. This information is then disseminated to the content creator and end-user for review. The end-user may then request a payment via a payment center. The payment center may be implemented as part of the online website and also as part of the downloaded mobile application.

As the end-user sends SMS messages and generally engages in communications using his or her mobile device, content is embedded in the messages and visible to all recipients. The communications may contain content embedded by various means, such as included media, hyperlink, or other method. Clicked hyperlinks or other actions taken on received content may allow tracking of conversion rates as the recipient of the embedded content is forwarded to his or her eventual destination. In one embodiment, end-users are compensated by one cent for every message transmitted, up to a maximum of five thousand messages for a given time period.

The data analysis server can then analyze individual usage data and aggregate it to create a payment or a reward for the user via the payment center. This information is forwarded back to the central server database for record keeping, as well as to the end-user's downloaded mobile application. Content creators receive this information as anonymized statistics. General usage statistics, lists of content and creators, and individual anonymized usage statistics are made available through a web portal, allowing for transparency regarding usage, payments, and other rewards between users, content creators, and the system owner and implementer.

Another embodiment of the instant system and method allows end-users to endorse a company's brand by embedding brand advertisements in messages. This would create credibility for the brand, as it appears to recipients that the brand has been recommended by a friend.

Another embodiment of the instant system and method involves the distribution of digital gifts. An end-user could purchase a credit to download digital content that has been listed in the system by a content provider. The end-user would then select a recipient for the gift from his or her contact list, and embed the gift into a message to that recipient.

Another embodiment of the instant system and method would allow for the ability to distribute alerts for missing children, such as Amber Alerts. Outgoing messages would include embedded Amber Alerts or other warnings, appropriately tailored to the end-user's location.

There has thus been outlined, rather broadly, the more important features of a system and method for sharing and/or endorsing content in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways, including applications involving not only firefighters. Also, it is to be understood that the phraseology and terminology employed herein are for the purpose of description and should not be regarded as limiting.

These together with other objects of the invention, along with the various features of novelty, which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

FIG. 1 illustrates a block diagram of an exemplary distributed computer system and networked environment for implementation of instant system and method.

FIG. 2 illustrates a flow diagram from the perspective of an individual content creator and how the content creator interacts with the system.

FIG. 3 illustrates a flow diagram from the perspective of an individual user and how the user interacts with the system and is enabled to share and/or endorse content provided by a content creator.

FIG. 4 illustrates a flow diagram of the data analysis performed by the system for the usage statistics generated through the content creators and users interaction with the system.

### DETAILED DESCRIPTION OF THE PREFERRED EMBODIMENTS

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments.

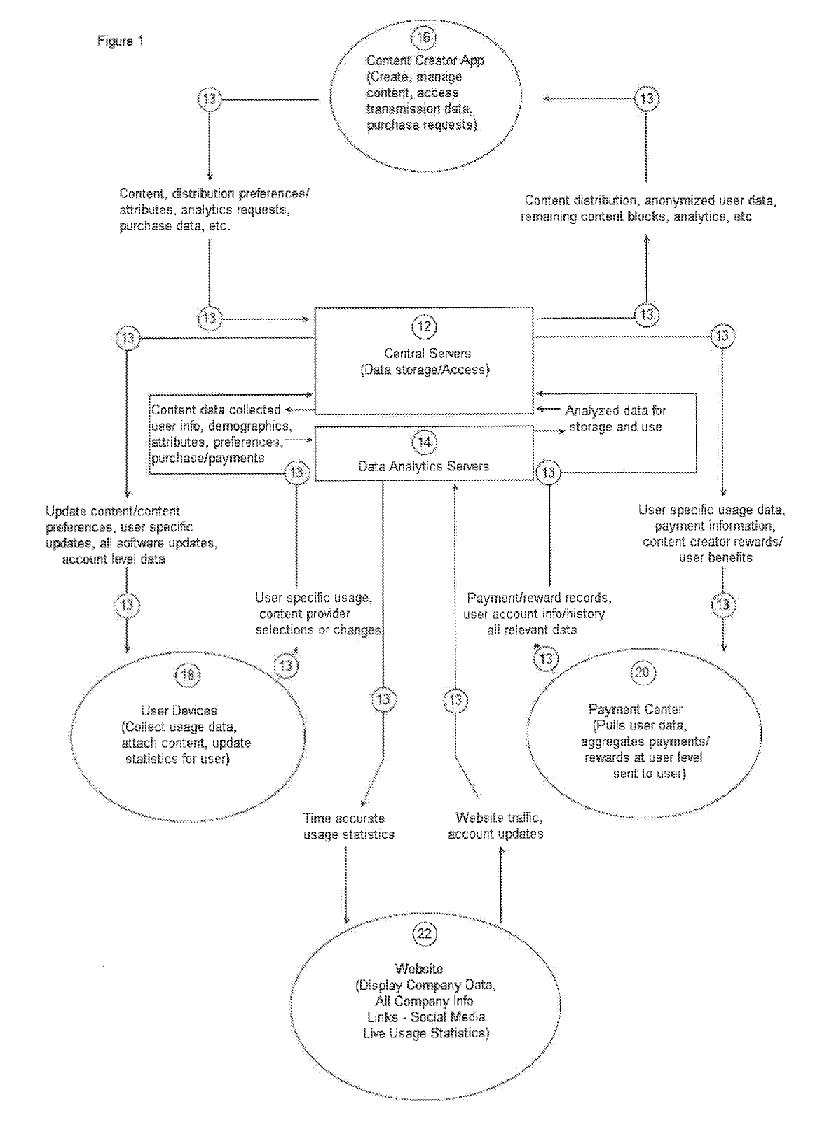

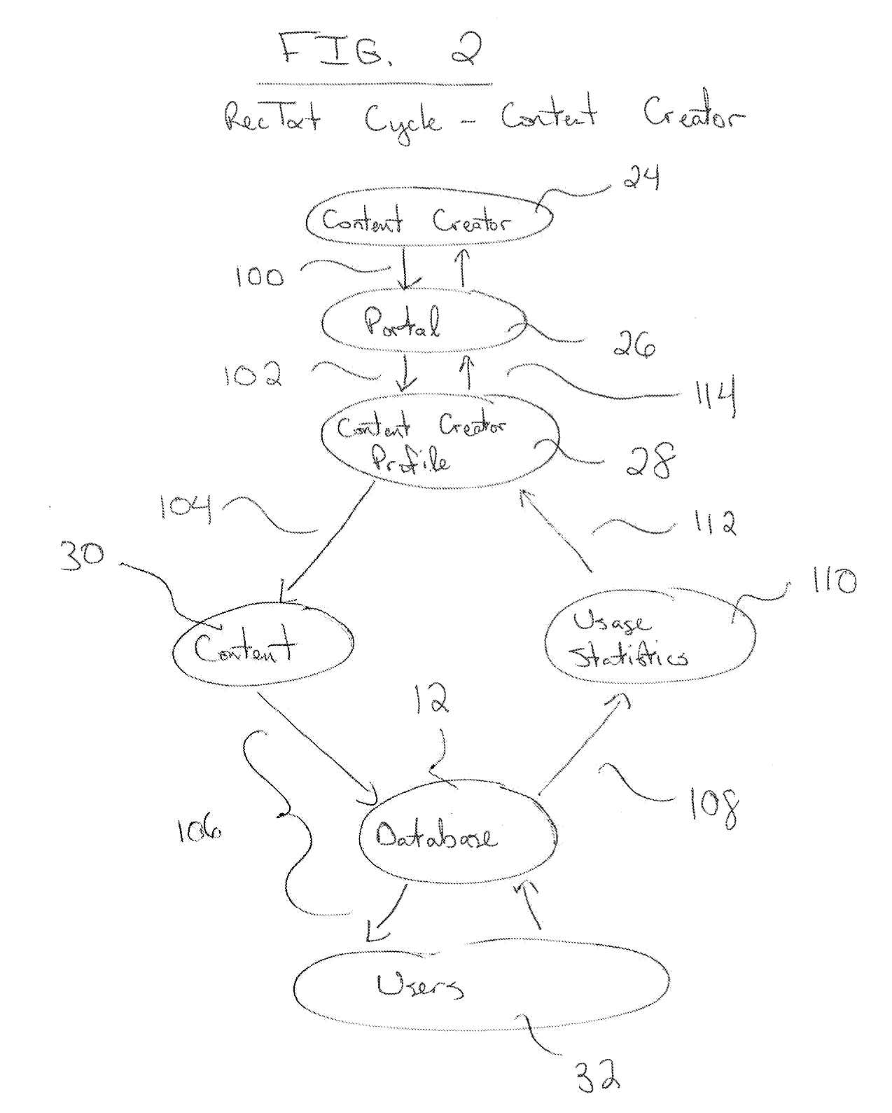

FIG. 1 illustrates a block diagram of one embodiment of the instant invention, wherein a system 10 and associated method (see FIGS. 2-4) enable individual users of the system 10 to preferably share and/or endorse a set of information by actively embedding the information within a user's existing communications, which include but are not limited to a laptop computer, a desktop computer, a smart phone, a tablet, or any other similar networked and internet-ready device. Additionally, the system 10 is preferably configured to enable a content creator (i.e. an individual responsible for creating the set of information for the user of the system 10 to embed within the user's existing communications) to monitor the content distribution to users of the system in real-time, while simultaneously possessing the ability to analyze any and all statistics related to the content distribution and/or the users receiving the content distribution. Moreover, another embodiment of the system 10 creates a financial incentive/reward program that may be accessible by users of the system 10 as a result of distributing the content described above.

In one embodiment of the instant invention, the system 10 operates in an electronically interconnected computer environment, and includes at least one central database server 12, wherein the central database server 12 preferably maintains records of a user's endorsements selected by the user's account, a set of demographic information of each user per the user's account, a set of content usage per user per endorsed company per account, any updates to content provided by each content creator, a total revenue generated by each user of the system 10 based on each user's content distribution, and any other additional information, or any analysis of that information; in the preferred embodiment of instant invention, the central database server 12 will be the primary location of data transactions for all devices and/or applications associated with the system 10.

The system 10, further includes at least one data analysis server 14, wherein one embodiment of the instant invention, all data analysis occurs on the data analysis server 14 to preferably limit the total strain on the central database server 12. Furthermore, as the potential exists for millions of data transactions per hour, it will be critical to save processing priority for data transfer (time sensitive) and more efficient to use separate processing power for the analysis/predictive modeling. As described in detail below, the collected and analyzed data preferably will be transmitted back to the central database server 12 from the data analysis server 14, to be distributed throughout the system 10 where needed. In one embodiment, the central database server 12 and the data analysis server 14 may be connected to an external network 13, including but not limited to the Internet.

Additionally, the system 10 includes a content creator application 16, wherein the content creator application 16 preferably functions as a modular to perform and provide a variety of needs for each content creator (see FIG. 2) including, but not limited to making purchases of ad-blocks, specifying time/location/other parameters for ad buys, and to receive the collected data analysis from the central database server 12 and/or data analysis server 14, with the additional option for direct mailing opportunities, should the content creators desire to purchase those options. Moreover, the content creator application 16 will track ads sent until uploaded to the central database server 12 and/or the data analysis server 14; the content creator application 16 also preferably possesses the ability to pause ad placement.

The system further includes a plurality of individual user devices 18, wherein each individual user device 18 is preferably networked to the system 10 through the external network 13, and in electronic communication with the system 10 and associated elements via the Internet connection or other similar connection means. In one embodiment, the user device 18 is selected from the group consisting of a laptop computer, a desktop computer, a smart phone, a tablet, and any other internet-ready mobile device. In one embodiment of the instant invention, each individual user device 18 may be responsible for positioning pre-written ads into messages by the user based off of the user's endorsement preferences.

Finally, the system 10 may include and coordinate with a payment center 20 via the external network 13, including any known in the art payment systems such as PayPal, brand gift cards, and prepaid credit card type gift cards disposed to orchestrate payment to the individual users of the system 10 based on a user's endorsement, sharing and overall content distribution. Apart from usage statistics, direct and/or online mail opportunities may be utilized to create a packing list for each payment sent.

FIG. 1 also illustrates one embodiment of the flow/process of information within the system 10, wherein initially, a content creator may log into an online profile available through a portal on a hosted website 22 and networked with the system 10 through the external network 13 to enable each content creator to create an online profile, create/upload content that each content provider desires to share with individual users of the system 10, which include, but are not limited to advertising, data, media, messaging, and any other similar means of data/information communication. Subsequently, each content creator may acquire a block of messaging access, which gives them access to a predetermined amount of total disseminations of content to users through the system 10. In an alternate embodiment, each content creator may be provided with the opportunity to structure their individual content distribution with attributes for distribution, including, but not limited to a preferred time, day, date, location, or other similar attributes. Once each content creator has submitted an online profile through the hosted website 22, and set the above parameters, this information may be electronically transmitted via the external network 13 and uploaded to the central database server 12 and/or data analysis server 14.

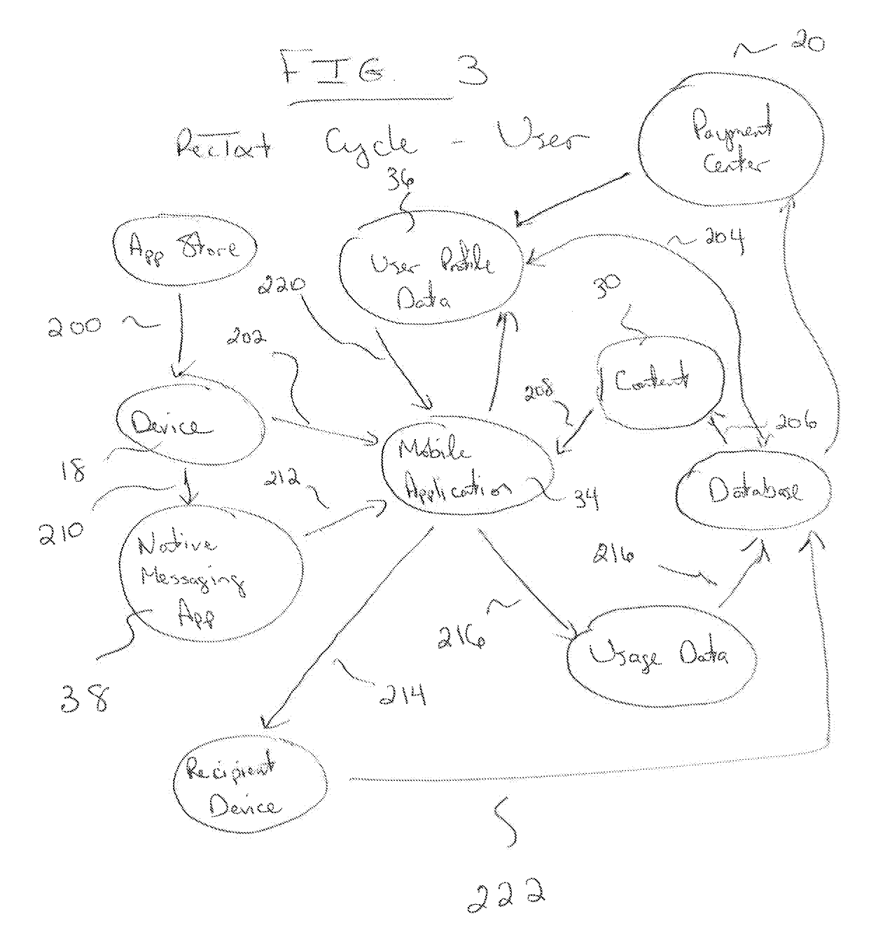

A user of the system 10 initially interacts with the system 10 by downloading a mobile application onto the user's device 18, wherein the mobile application may be available on a shared network environment (see FIG. 3). Once the user has downloaded the mobile application onto the user's device 18, the user may create a profile using the mobile application that includes basic demographic information, a method of contact, payment information, and/or any other information relevant to each content creator. Following the creation of a profile by the user, the mobile application enables the user to choose and select from a list of content creators that they wish to endorse or share in the messages distributed by the content creators; this function may be accomplished through the mobile application, or via a link embedded by each content creator. Thus, once the user has made their selections of content creators, the mobile application transmits the selections to the central database server 12 via electronic communication, and in turn the central database server 12 transmits a set of relevant content related to each selected content creator to the individual user's device 18. Furthermore, the relevant content transmitted from the central database server 12 to the user's device 18 may be embedded within the device's 18 communications (i.e. in an SMS message, instant message, or email); the usage information (including attributes) from the user's profile is then saved, uploaded to the central database server 12, and the user's identity is shielded.

In one embodiment of the instant invention, the collective data of all of the users of the system 10 is saved to the central database server 12; this collective data may be analyzed to establish revenue, generate payments and rewards for the individual users of the system 10, monitor content distribution by each content creator, and may separately be utilized to extract data for paid analysis and/or predictive modeling, etc. The relevant information is then disseminated to the content creator accounts, the user application and accounts, the payment center 20, the hosted website 22 for live updates, etc.; all data is stored for alternate analysis. A recipient receives messages from the users with content embedded, either by media, short link, or other method; short links or other actions on received content allow tracking of conversion rates as the user is forwarded to their eventual destination.

Additionally, the payment center 20 may take individual usage data and aggregate it to create a payment and/or reward for a user of the system 10. This information is filtered back to the central database server 12 for record keeping, as well as to the content creators as anonymous statistics and back to the user's device 18 via the mobile device for record keeping. The general usage statistics, list of content and creators, and individual usage statistics are made available through the web portal as well via entry by the user or content creator on the hosted website 22.

FIG. 2 illustrates a flow diagram from the perspective of an individual content creator and how the content creator interacts with the system 10. Initially, a content creator 24 gains access to the system 10 and associated network through a portal 26 that is preferably located on the hosted website 22 associated with the system 10 and accessible via the external network 13. In one embodiment, the hosted website 22 will serve as a central point of contact for users of the system 10, for marketing purposes, and for individual's looking to contact the site hosts.

Therefore, at step 100, the individual content creator 24 will access the portal 26 through the hosted website 22, and at step 102, upon entry, each individual content creator 24 will be prompted to create an online profile 28 by the hosted website 22; the online profile 28 may include information including, but not limited to the company or brand associated with each content creator 24, a logo, general information about the content created and distributed by the content creator 24, contact information for verification, payment information, etc. Additionally, the online profile 28 on the website 22 will be utilized to generate a landing page for the content creator 24, where the content creator 24 may manage their data, purchase blocks of distribution, and add content; the logo and company name/info provided in the online profile 28 will be utilized by the system 10 to generate a list of content creators 24 available to the users of the system 10 to share and/or endorse the content distributed by the respective content creator 24. Following the generation of the online profile 28, at step 104, the content creator 24 will be able to create a set of content 30 in the form of advertisements and/or any other means of information that they want to distribute to users of the system 10. In one embodiment, the content 30 may include text, advertising, media, or other information; the content provider 24 will also be able to select a number of attributes that the content creator 24 believes will better target the users of the system 10, such as preferred times, dates, days, locations, etc. to deliver the associated content 30. Lastly, each content creator 24 will need to purchase a block of distribution, at which point their content 30 will go live. At step 106, the content 30 generated by each content creator 24 will be distributed to a user 32 of the system 10 onto the user's mobile device 18 via the central database server 12, as each user 32 selects new content distributors to the user's 32 respective profile; the content 30 will fall into a hierarchy based upon their attributes, and the users' profile information.

Once the content 30 has been transmitted to the user 32, the user's 32 mobile application collects data on the content distribution by the content creator 24, and transmits this information back to the central database server 12 to be logged, including total content sent, content by distributor, applicable attributes applied, the user's anonymized demographic information, etc. at step 108; all of this information is stored for use. Following this transmittal, a set of usage statistics 110 by each content creator 24 is aggregated; the usage statistics 110 are used to determine how much of the distribution block has been used, how much is remaining, and the effective targeting. At step 112, the usage statistics 110 are then copied over to the content creator's 24 profile 28 via the data analysis server 14 and available on the website 22 for viewing; the transfer is made available in real time and the profile updates for each content creator 24 are made visible through the portal 26 at step 114. Lastly, at step 116, the content creator 24 logs back into the system 10 through the hosted website 22 to view their updated profile information, manage/edit content to be distributed, add blocks of distribution, modify their attributes, etc.; this information may be viewed or modified in real time.

FIG. 3 illustrates a flow diagram from the perspective of an individual user 32 and how the user 32 interacts with the system 10 and is enabled to share and/or endorse content 30 provided by a content creator 24. At step 200 the user 32 will download a mobile application 34 to their individual device 18 which may be done by accessing the mobile application 34 through an online marketplace, such as Google Play or iOS App Store. In one embodiment, the mobile application 34 will provide an interface for the user 32 to manage settings, select content to distribute, and to retrieve their own usage statistics. Additionally, the mobile application 34 may interface with native applications for communication, such as an SMS app, an instant message application, email program, etc. At step 202, the user 32 will set up a profile 36 through the mobile application 34 that will include basic demographic information, including, but not limited to age, zip code, and gender. Furthermore, the user 32 will need to select a payment option that they prefer to use, and supply payment information for the payment center 20. Additionally, the user 32 will be required to select the content 30 the user 32 wishes to distribute from the content creator 24, which may be altered at any time. Also, in one embodiment, the mobile application 34 will allow the user 32 to pause distribution, in the instance that they do not wish to distribute content 30 for a period of time.

At step 204, the profile 36 created by the user 32 will be processed by the mobile application 34 anonymously, and will be uploaded to the central database server 12. The profile 36 created by the user 32 will set the parameters that the central database server 12 will use to determine what information to send the user 32, what content 30 to send to the user's device 18 for distribution, and also for data tracking purposes, for the profile's preferences, content providers, and usage statistics. At step 206, the central database server 12 will send a set of content 30 for distribution to the user's device 18 as updates are requested, either by the content creators 24, or user profile updates. The content 30 will also be assigned any number of attributes for preference, for example, that content 30 is best distributed at a certain time or times, on certain days, to certain locations/area codes, associated by keyword, or other possible attributes, which may be implemented in real time. Subsequently, at step 208, the user's device 18 receives the updates, and the mobile application 34 updates a revolving distribution list of content 30 selected by the user 32, with the hierarchy assigned by the attributes disseminated with the content 30. At step 210, the user 32 opens a native messaging application 38 on their device 18 to create and send a message; once the message is complete, the user 32 sends the message. At step 212, the message is transmitted to the mobile application 34, for content addition. At step 214, the mobile application 34 scrapes a set of data from the message for information that may apply to attributes, such as area code, time, date, day, location, keyword match, etc., and adds content 30 to the end of the message. The mobile application 34 then logs the addition/attributes involved, and then complete the transmission of the message to the recipient. Next, at step 216, the mobile application 34 transmits the usage statistics 110 (including content distribution totals, what content has been distributed, and any other analytically pertinent information) back to the central database server 12 to be saved under the profile of the specified user 32. At step 218, the individual profile data 36 stored on the central database server 12 is used to generate payment, either by reaching a predefined period of time or minimum payment; the information is gathered and sent to the payment center 20 for verification. At step 220, once the payment information is verified, the information is used to send a payment to the user 32, based on the specified method in their payment profile, and the information is logged, then sent to the user's device 18 for display on the mobile application 34. Finally, at step 222, the short links or other actions will go to a landing page which will forward to the destination, and these landing pages will track conversions; conversion data is saved to the data analysis server 14 for analysis.

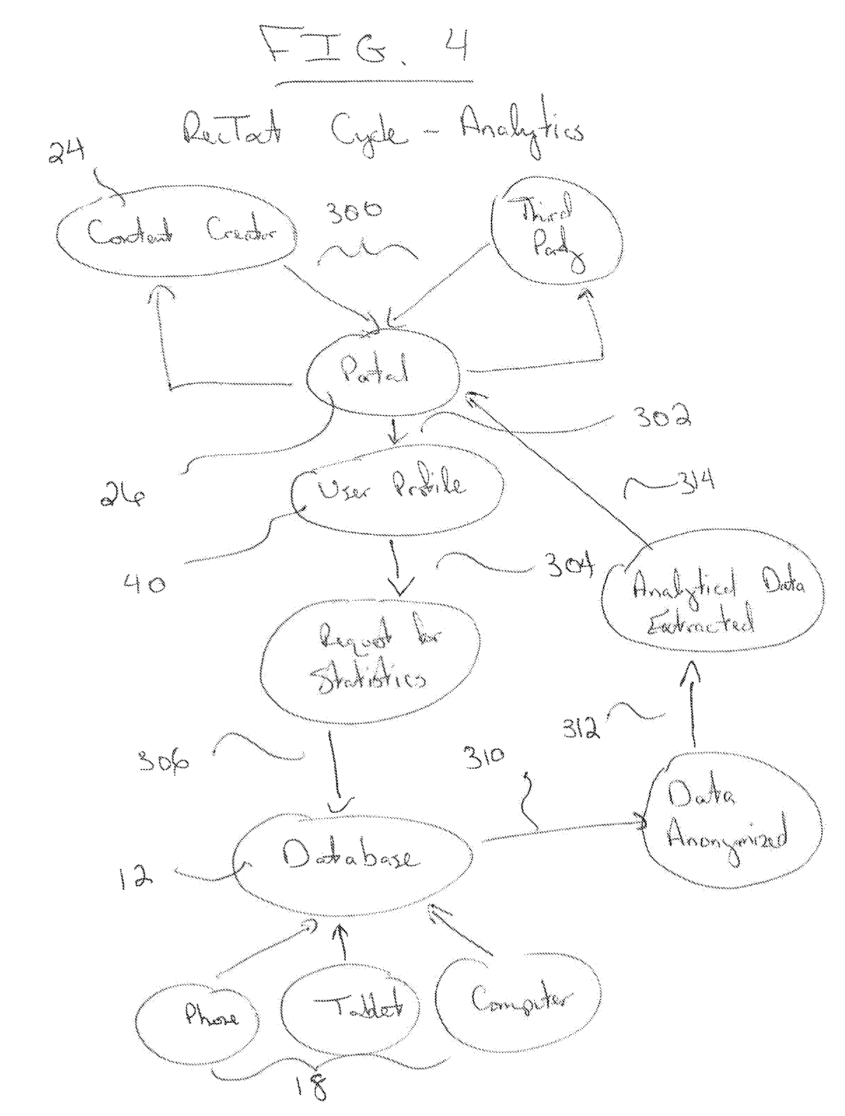

FIG. 4 illustrates a flow diagram of the data analysis performed by the system 10 for the usage statistics 110 generated through the content creators 24 and users 32 interaction with the system 10. Initially, at step 300 content creators 24 and/or other clients (separate from users 32) of the system 10 may gain access to the data stored on the data analysis server 14 through the portal 26, located on the website 22. Additionally, the website 22 will also serve as a point of contact for users 32, for marketing, and for people looking to contact the company. At step 302, following entry via the portal 26, the content creator/client will need to create a profile 40; the data collected will include the company or brand, contact information for verification, payment information, etc. At step 304 the content provider/client will request a data analysis, which may include, but is not limited to data on the effectiveness of a certain ad campaign, the loyalty of a brand's users in a certain location, a certain demographic, the market penetration of a particular type of product, or any information that we can draw out of our statistical database.

The request is submitted to the central database server 12 at step 306, wherein the system 10 will review the request, determine the best methods of isolating metrics or creating an analytical model, and the relevant information required to do so. At step 308, the system 10 will then submit queries for this information to the central database server 12. The central database server 12 will collect all relevant statistics and data for analysis from anonymized data, based upon relevant content, attributes, conversions, times, demographics, etc. at step 310. This data will be analyzed and interpreted; possible further queries will take place to refine findings and the findings will then be formalized into reports, with simplified answers, any visual representations, and all relevant anonymized data attached at step 312. These reports/data are assigned to their respective profiles, and made available to the content provider/client, and finally at step 314 the content provider/client logs in to the portal 26 to view their profile, reporting, analysis, and attached data.

Additional embodiments of the instant invention and system 10 may include allowing advertisers and brands to allow their loyal users to endorse the brand by embedding advertisements into the clients existing messages. In this embodiment, a user could select the brands that they wish to endorse, and the mobile application 34 would passively embed ads created by the advertisers into messages as they are sent. Under this scenario, the system 10 would create credibility for the brand, as it is being recommended by a friend, and also targeted marketing, as the recipients are likely to share interests with the user. The recipient receives relevant advertising, with a direct link or call to action, eliminating extra steps/effort. The user gets paid per message delivered, and the advertiser/brand has the ability to reward a loyal endorser directly as they see fit.

Another embodiment of the invention would be for distribution of digital gifts. A user could purchase the a credit to download digital content, i.e. a movie or an album from the content owners, and embed the gift into an existing message, while allowing the content creator to accurately track content distribution, and possibly reward users who purchase/disseminate a large amount of content.

Another embodiment of the invention would be the ability to distribute Amber Alerts, or other warnings. The user could add a feed for amber alerts to their profile, and the messages could be added directly to their existing messages, for distribution by area code or other location based tracking, and would allow the feed to see the total number of messages disseminated. This would also allow the recipients a direct call to action if they were able to act on a warning, either by dialing directly from a mobile, or sending a message with pertinent information to a location specified by short link.

In conclusion, herein is presented a computer-implemented system and method for individuals to share and/or endorse content. The invention is illustrated by example in the flow diagrams and figures, and throughout the written description. It should be understood that numerous variations are possible, while adhering to the inventive concept. Such variations are contemplated as being a part of the present invention.

What is claimed is:

1. A method for sharing and endorsing content generated by a content creator, the method comprising the steps of:
downloading a mobile application from a shared network environment onto a user device;
creating a profile by the user through the mobile application on the user device;
processing the profile by the mobile application to allow the user to remain anonymous;
uploading the profile to a central database server from the user device through an external network; and
transmitting a set of content for distribution from the central database server to the mobile application on the user device.

2. The method for sharing and endorsing content generated by a content creator of claim 1 further comprising the steps of:
selecting a list of content creators by a user through the mobile application that the user wants to share and endorse;
transmitting the selected list of content creators from the user device to the central database server via the external network;
analyzing the selected list of content creators by the central database server; and
sending the selected content to the user's device from the central database server through the external network.

3. The method for sharing and endorsing content generated by a content creator of claim 2 further comprising the steps of:
embedding the content sent from the central database server within the user's device's communications.

4. The method for sharing and endorsing content generated by a content creator of claim 3, wherein the device's communications is selected from the group consisting of SMS message, instant message or electronic mail.

5. The method for sharing and endorsing content generated by a content creator of claim 3, further comprising the steps of:
opening a native messaging application on the user's device;
transmitting a message to the mobile application on the user's device;
embedding a set of content on the message by the mobile application; and
transmitting the message to a recipient through the external network.

6. The method for sharing and endorsing content generated by a content creator of claim 5, wherein the content is embedded in the message by a means selected from the group consisting of: media, hyperlink and short link.

7. The method for sharing and endorsing content generated by a content creator of claim 5, further comprising the steps of:
tracking the content distribution by the user to recipients by the central database server;
transmitting the content distribution by the user from the central database server to a payment center through the external network; and
providing a payment to the user by the payment center based on the amount of content distribution by the user.

8. The method for sharing and endorsing content generated by a content creator of claim 1 further comprising the steps of:
selecting a set of parameters by the user through the mobile application to receive the content from the central database server; and
uploading the selected parameters from the user's device to the central database server through the external network.

9. The method for sharing and endorsing content generated by a content creator of claim 1 further comprising the steps of:
assigning a set of attributes to the content for distribution to the user by the central database server.

10. The method for sharing and endorsing content generated by a content creator of claim 9 wherein the set of attributes for content distribution is selected from the group consisting of: date, time, location, area code and keyword.

11. A method for sharing and endorsing content generated by a content creator, the method comprising the steps of:
accessing a system for individuals to share and endorse content by a content creator through a portal located on a hosted website;
creating an online profile by the content creator on the website;
creating a set of content by the content creator for distribution to a user of the system; and
distributing the set of content to a device of the user from a central database server through an external network.

12. The method for sharing and endorsing content generated by a content creator of claim 11, further comprising the steps of:
collecting a set of data on the content distribution from the content creator by a mobile application on the user's device;
transmitting the set of data collected from the mobile application to the central database server; and
generating a set of usage statistics by the central database server for each content creator.

13. The method for sharing and endorsing content generated by a content creator of claim 11 further comprising the steps of:
assigning a set of attributes to the content for distribution to the user by the central database server.

14. The method for sharing and endorsing content generated by a content creator of claim 13 wherein the set of attributes for content distribution is selected from the group consisting of: date, time, location, area code and keyword.

15. The method for sharing and endorsing content generated by a content creator of claim 11 further comprising the steps of:
embedding the content sent from the central database server within the user's device's communications.

16. A method for sharing and endorsing content generated by a content creator, the method comprising the steps of:
downloading a mobile application from a shared network environment onto a user device;
creating a profile by the user through the mobile application on the user device;
processing the profile by the mobile application to allow the user to remain anonymous;
uploading the profile to a central database server from the user device through an external network; and
accessing a system for individuals to share and endorse content by a content creator through a portal located on a hosted website;
creating an online profile by the content creator on the website;
creating a set of content by the content creator for distribution to a user of the system;
selecting a list of content creators by the user through the mobile application that the user wants to share and endorse;
transmitting the selected list of content creators from the user device to the central database server via the external network;
analyzing the selected list of content creators by the central database server; and
transmitting the selected content for distribution from the central database server to the mobile application on the user device.

17. The method for sharing and endorsing content generated by a content creator of claim 16 further comprising the steps of:
embedding the content sent from the central database server within the user's device's communications.

18. The method for sharing and endorsing content generated by a content creator of claim 17, wherein the device's communications is selected from the group consisting of SMS message, instant message or electronic mail.

19. The method for sharing and endorsing content generated by a content creator of claim 16, further comprising the steps of:
opening a native messaging application on the user's device;
transmitting a message to the mobile application on the user's device;
embedding a set of content on the message by the mobile application; and
transmitting the message to a recipient through the external network.

20. The method for sharing and endorsing content generated by a content creator of claim 19, wherein the content is embedded in the message by a means selected from the group consisting of: media, hyperlink and short link.
